(19) United States
(12) Patent Application Publication
(10) Pub. No.: US 2016/0289528 A1
(43) Pub. Date: Oct. 6, 2016

(54) PROTEIN-BASED FIBROUS BRIDGING MATERIAL AND PROCESS AND SYSTEM FOR TREATING A WELLBORE

(71) Applicant: HALLIBURTON ENERGY SERVICES, INC., Houston, TX (US)

(72) Inventors: Vikrant B. WAGLE, Mumbai (IN); Omprakash R. PAL, Mumbai (IN); Sandeep D. KULKARNI, Kingwood, TX (US)

(21) Appl. No.: 15/038,688

(22) PCT Filed: Feb. 26, 2014
(86) PCT No.: PCT/US14/18738

§ 371 Date: May 23, 2016

(51) Int. Cl. C09K 8/035; C09K 8/42; E21B 33/138; E21B 21/00; E21B 21/06; C09K 8/40; C09K 8/536

(52) U.S. Cl. CPC C09K 8/035; C09K 8/40; C09K 8/42; C09K 8/536; E21B 21/003; E21B 21/062; E21B 33/138; C09K 2208/08; C09K 2208/04; C09K 2208/18

(57) ABSTRACT

A bridging material for a well treatment fluid that comprises a protein-based fibrous material and at least one additional material is provided. For example, the protein-based fibrous material can be soy protein fiber (SPF).The additional material is a lost circulation material. A process for treating a wellbore penetrating a subterranean formation with minimal or no loss of treatment fluid into the formation is also provided. A system for drilling a wellbore from the surface into a subterranean formation with minimal or no loss of drilling fluid into the formation is also provided.

### BACKGROUND

In the process of drilling an oil and gas well, drilling fluid (also known as drilling mud) is injected through the drill string and caused to flow down to the drill bit and back up to the surface in the annulus between the outside of the drill string and the wellbore. The drilling fluid serves multiple purposes. For example, the drilling fluid lubricates and cools the drill bit and carries the drill cuttings away from the bottom of the wellbore to the surface. The drilling fluid is also used to prevent blowouts or kicks by maintaining a hydrostatic head pressure on the wellbore.

A common problem that is encountered in the process of drilling an oil and gas well is a loss of circulation of the drilling fluid, referred to as lost circulation. Lost circulation occurs when all or a portion of the drilling fluid is lost into a subterranean formation penetrated by the wellbore. Such a condition can substantially lower the volume of drilling fluid in the wellbore and in turn lower the head pressure applied to the wellbore. Lost circulation is one of the more costly problems faced while drilling oil and gas wells. It is particularly a problem when drilling through weak or unconsolidated formation zones.

A variety of factors may contribute to lost circulation. For example, subterranean formations traversed by wellbores may be highly permeable, weak, and/or fractured. Some formations may not be able to withstand the hydrostatic pressure created by the drilling fluid in the wellbore. The hydrostatic pressure may force the drilling fluid into naturally occurring or induced fractures, fissures, vugs and/or porous regions associated with the wall of the wellbore, or may break down the wall of the wellbore altogether.

In addition to drilling fluids, lost circulation may also be encountered in association with other types of wellbore treatment fluids including cement compositions and slurries, fluids used to remove cuttings from wellbores, wellbore cleaning fluids, sealant compositions, completion fluids (for example, completion brines), workover fluids and spacer fluids. For example, lost circulation of the cement composition during a primary cementing application such as a process for cementing the casing in the wellbore can cause premature dehydration of the cement composition, potentially leading to an excessive viscosity and potential termination of the cementing process.

A common method of controlling lost circulation entails the introduction of “lost circulation materials” (commonly referred to as “LCMs”) to the wellbore treatment fluid (for example, the drilling fluid or cement composition) to form bridges in and plug the fractures or other openings in the wellbore wall through which the treatment fluid is being lost. The lost circulation materials flow toward the problematic fractures or other openings and form bridges or plugs therein to stop or reduce the amount of treatment fluid being lost through the wellbore wall.

Classifications of lost circulation materials that can be used include fibrous lost circulation materials (for example, polymer fibers and cellulose fibers), flaky lost circulation materials (for example, mica flakes and cellophane sheeting), and particulate lost circulation materials (for example, sized limestone or marble, wood, nut hulls, corncobs and cotton hulls). The type(s) of lost circulation material(s) that are used in a given wellbore treatment will depend on the type of treatment, the conditions associated with the well, availability and other factors known to those skilled in the art.

### BRIEF SUMMARY

In a first aspect, the invention is a bridging material for a wellbore treatment fluid. The bridging material comprises a protein-based fibrous material and at least one additional material. The additional material is a lost circulation material.

In a second aspect, the invention is a process for treating a wellbore penetrating a subterranean formation with minimal or no loss of treatment fluid into the formation. The process comprises the steps of: (a) providing a treatment fluid that includes a bridging material; and (b) introducing the treatment fluid into the wellbore. The bridging material comprises a protein-based fibrous material and at least one additional material. The additional material is a lost circulation material.

In a third aspect, the invention is a system for drilling a wellbore from the surface into a subterranean formation with minimal or no loss of drilling fluid into the formation. The system comprises: a source of drilling fluid; a source of bridging material; and a wellbore drilling assembly associated with the source of drilling fluid and the source of bridging material.

The bridging material used in connection with the inventive system comprises a protein-based fibrous material and at least one additional material. The additional material is a lost circulation material.

The wellbore drilling assembly of the inventive system includes a drilling platform and a derrick supported by the drilling platform. The derrick has a traveling block. A drill string that can be raised and lowered by the traveling block is also included. The drill string has an interior and a distal end. A drill bit is attached to the distal end of the drill string, whereby the drill bit can be rotated to create the wellbore. The drill bit has one or more orifices therein. A mixing apparatus is included for admixing bridging material from the source of bridging material into drilling fluid from the source of drilling fluid. A pump for circulating drilling fluid including the bridging material from one of the source of drilling fluid and the source of bridging material through the interior of the drill string, through said orifice(s) of the drill bit and back to the surface through an annulus defined between the drill string and the wall of the wellbore is also included.

The inventive bridging material, inventive process and inventive system can be used in a variety of applications, including to minimize or control lost circulation and to strengthen the wellbore in weak or unconsolidated subterranean formations.

### BRIEF DESCRIPTION OF THE DRAWING

The drawing is provided to illustrate certain aspects of the invention and should not be used to limit or define the invention.

FIG. 1 is a schematic illustration generally depicting a land-based drilling assembly.

### DESCRIPTION OF SPECIFIC EMBODIMENTS

In a first aspect, the invention is a bridging material for a wellbore treatment fluid. For example, the inventive bridging material can be added to the drilling fluid used in drilling a wellbore into a subterranean formation in order to minimize or prevent loss of the drilling fluid into the formation. In a second aspect, the invention is a process for treating a wellbore penetrating a subterranean formation with minimal or no loss of the treatment fluid into the formation. For example, in one embodiment, the invention is a process for drilling a wellbore into a subterranean formation with minimal or no loss of drilling fluid into the formation. In a third aspect, the invention is a system for drilling a wellbore from the surface into a subterranean formation with minimal or no loss of drilling fluid into the formation.

As used herein and in the appended claims, a “bridging material” means a material such as a lost circulation material that forms bridges in, plugs and/or solidifies one or more areas around the periphery of a wellbore in which a treatment fluid (for example, drilling fluid) is being or has the potential to be lost to an adjacent subterranean formation. A wellbore treatment fluid means a fluid used in association with forming a wellbore, treating a wellbore and/or treating a subterranean formation penetrated by a wellbore. For example, as used herein, the treatment fluid can be a drilling fluid, a cement composition or slurry, a fluid used to remove cuttings from a wellbore, a wellbore cleaning composition, a sealant composition, a completion fluid (for example, a workover fluid) and/or a spacer fluid.

The inventive bridging material comprises a protein-based fibrous material and at least one additional material, the additional material being a lost circulation material.

For example, the protein-based fibrous material can be selected from the group consisting of soy protein fiber, milk protein fiber, and mixtures thereof. The additional material can be selected from the group consisting of non-protein based fibrous materials, flaky materials and particulate materials.

As used herein and in the appended claims, soy protein fiber (“SPF”) means and includes soy protein fiber, soya protein fiber, soya fiber and soy fiber. SPF is a protein fiber made from soybean cake. It is a mixture of cellulosic and non-cellulosic structural components from the internal cell wall of the soybean. As used herein, milk protein fiber (“MPF”) means and includes milk protein fiber and milk fiber. MPF is a protein fiber made from milk (for example, dewatered and skimmed milk). It is commonly manufactured into a protein spinning fluid suitable for a wet spinning process for use in the textile industry. For example, MPF can be a blend of casein protein (found in milk) and acrylonitrile. SPF and MPF have similar chemical structure and properties.

For example, in one embodiment, the protein-based fibrous material of the inventive bridging material is of a size (for example, length and diameter) and used in a concentration that provides the desired lost circulation control without undesirable interaction with equipment (for example, pumps, drill bits, etc.). For example, the protein-based fibrous material of the inventive bridging material can have a length to diameter aspect ratio in the range of from about 2:1 to about 5,000:1. In one embodiment, the protein-based fibrous material of the inventive bridging material has a length to diameter aspect ratio in the range of from about 50:1 to about 2000:1. By way of further example, the protein-based fibrous material of the inventive bridging material can have a fiber length in the range of from about 0.5 mm to about 25 mm In one embodiment, the protein-based fibrous material of the inventive bridging material has a fiber length in the range of from about 1 mm to about 12 mm For example, the density of the protein-based fibrous material can be in the range of from about 0.5 g/cm³ to about 4.5 g/cm³. In one embodiment, the protein-based fibrous material has a density in the range of from about 0.5 g/cm³ to about 2 g/cm³.

For example, the protein-based fibrous material can be SPF. Physical properties of SPF are set forth below:

TABLE 1
Physical Properties of Soy Protein Fiber (SPF)

| Property | | SPF |
|---|---|---|
| Breaking Strength | Dry | 3.8-4.0 |
| (CN/dtex) | Wet | 2.5-3.0 |

| | |
|---|---|
| Dry breaking extension (%) | 18-21 |
| Initial Modulus (kg/mm²) | 700-1300 |
| Loop strength (%) | 75-85 |
| Knot strength (%) | 85 |
| Moisture regain (%) | 8.6 |
| Density (g/cm³) | 1.29 |

Examples of lost circulation materials that can be used as the additional material of the inventive bridging material include, but are not limited to: ground coal; petroleum coke; sized calcium carbonate; asphaltene; perlite; cellophane; cellulose; ground tire material; ground oyster shell; vitrified shale; plastic material; paper fiber; wood; cement; hardened foamed cement; glass; foamed glass; sand; bauxite; ceramic material; polymeric material (such as ethylene vinyl acetate); polytetrafluoroethylene material; nut shells; seed shell pieces; fruit pit pieces; clay; silica; alumina; fumed carbon; carbon black; graphite; mica; titanium oxide; meta-silicate; calcium silicate; kaolin; talc; zirconia; boron; fly ash; hollow glass microspheres; any composite particle thereof; and any combination thereof. Examples of suitable commercially-available LCMs include, but are not limited to, WALL-NUT®, BARACARB®, STEELSEAL®, N-SQUEEZE™, N-SEAL™, N-PLEX™, HYDRO-PLUG®, DURO-SQUEEZE™ H, BAROFIBRE®, and BAROFIBRE® O, marketed by Halliburton Energy Services, Inc. For example, BARACARB® is a sized-ground marble that has many uses including use as a bridging agent for fluid loss applications. STEELSEAL® is a resilient graphitic carbon product that also has many applications including use as a bridging and sealing agent.

In one embodiment, the additional material of the inventive bridging material is selected from the group consisting of non-protein based fibrous materials, flaky materials and particulate materials.

For example, the additional material of the inventive bridging material can be a non-protein based fibrous lost circulation material. Examples of non-protein based fibrous materials that can be used include cellulosic and synthetic fibers. Examples of synthetic fibers that can be used include, but are not limited to, polymers or copolymers composed of polypropylene, polyaramid, polyester, polyacrylonitrile, and polyvinyl alcohol. Examples of biodegradable fibers that can be used include, but are not limited to, fibers composed of modified cellulose, chitosan, modified chitosan, polycaprolactone, polylactic acid, poly(3-hydroxybutyrate), polyhydroxyalkanoates, polyglycolic acid (“PGA”), polylactic acid (“PLA”), polyorthoesters, polycarbonates, polyaspartic acid, polyphosphoesters or copolymers thereof. Examples of other suitable fibers that can be used include fibers of cellulose including viscose cellulosic fibers, oil coated cellulosic fibers, paper fibers; carbon including carbon fibers; melt-processed inorganic fibers including basalt fibers, wollastonite fibers, non-amorphous metallic fibers, ceramic fibers, and glass fibers. Suitable fibers can also be a composite fiber made from any combination of the preceding materials. Suitable fibers also include a mixture of fibers wherein the fibers are composed of different substances. A commercially-available example of suitable fibers is BAROLIFT®, a sweeping agent marketed by Halliburton Energy Services, Inc., which is a synthetic fiber.

For example, non-protein based fibrous lost circulation materials that can be used as the additional material of the inventive bridging material can have a length to diameter aspect ratio in the range of about 2:1 to about 5,000:1. By way of further example, non-protein based fibrous lost circulation materials that can be used as the additional material of the inventive bridging material can have a length to diameter aspect ratio in the range of about 50:1 to about 2000:1.

For example, the additional material of the inventive bridging material can be a flaky lost circulation material. Examples of flaky materials that can be used include mica flakes and plastic pieces.

For example, the additional material of the inventive bridging material can be a particulate lost circulation material. Examples of particulate lost circulation materials that can be used include nut hulls such as walnut hulls, cotton hulls, ground marble and ground limestone. For example, the particulate lost circulation material can be nut hulls. By way of further example, the nut hulls can be walnut hulls.

For example, particulate lost circulation materials suitable for use as the additional material of the inventive bridging material can have a d₅₀ particle size in the range of from about 5 μm to about 25,000 μm. By way of further example, particulate lost circulation materials suitable for use as the additional material of the inventive bridging material can have a d₅₀ particle size in the range of from about 37 μm to about 11,200 μm. In one embodiment, 90% of the material will pass through a 2 mesh sieve and be retained by a 400 mesh sieve.

The ratio of the protein-based fibrous material and the additional material(s) in the inventive bridging material can vary depending on the type of wellbore treatment and the conditions associated with the well. For example, the bridging material can comprise about 0.1% to about 50% by weight, based on the total weight of the bridging material, of the protein-based fibrous material, and in the range of from about 50% to about 99.9% by weight, based on the total weight of the bridging material, of the additional material(s). In another example, the bridging material can comprise about 0.1% to about 10% by weight, based on the total weight of the bridging material, of the protein-based fibrous material, and in the range of from about 90% to about 99.9% by weight, based on the total weight of the bridging material, of the additional material(s).

In addition to the protein-based fibrous material and additional lost circulation material(s), the inventive bridging material may include one or more fillers and additional materials depending on the particular application. In one embodiment, the additional components of the inventive bridging material are all of a size that provides the desired lost circulation control without undesirable interaction with equipment (for example, pumps, drill bits, etc.).

As illustrated below, the inventive bridging material may be used in a variety of wellbore treatment applications and in connection with a variety of wellbore treatment fluids to provide lost circulation control and to strengthen the wellbore and formation.

The inventive process for treating a wellbore penetrating a subterranean formation with minimal or no loss of treatment fluid into the formation comprises the following steps:

(a) providing a treatment fluid that includes the inventive bridging material, described above; and

(b) introducing the treatment fluid into the wellbore.

The amount of the inventive bridging material present in the treatment fluid used in the inventive process can vary depending on the nature of the treatment fluid and the type of treatment being carried out, the conditions and characteristics of the wellbore and adjacent subterranean formations, the extent of lost circulation or potential lost circulation and other factors known to those skilled in the art. For example, the protein-based fibrous material of the inventive bridging material can be present in the treatment fluid in an amount in the range of about 0.1 pounds to about 25 pounds of protein-based fibrous material per barrel of treatment fluid. By way of further example, the protein-based fibrous material of the inventive bridging material can be present in the treatment fluid in an amount in the range of about 0.1 pounds to about 10 pounds of protein-based fibrous material per barrel of treatment fluid. For example, the additional material of the inventive bridging material can be present in the treatment fluid in an amount in the range of about 0.1 pounds to about 100 pounds of the additional lost circulation material per barrel of treatment fluid. By way of further example, the additional material of the inventive bridging material can be present in the treatment fluid in an amount in the range of about 0.1 pounds to about 50 pounds of the additional lost circulation material per barrel of treatment fluid.

In practice, the bridging material can be added to the treatment fluid continuously to achieve the desired concentration as the treatment is carried out. For example, the bridging material can be added to the base treatment fluid on the fly as the treatment fluid is pumped down the hole. For example, if the treatment fluid is a drilling fluid and the inventive process is a process for drilling a wellbore penetrating a subterranean formation with minimal or no loss of treatment fluid into lost circulation areas, the inventive bridging agent can be added to the base drilling fluid on the fly as the drilling fluid is pumped down the hole.

The treatment fluid provided in accordance with the inventive process can be any type of treatment fluid in which bridging materials such as lost circulation materials are used. Examples include drilling fluids, cement compositions and slurries, fluids used to remove cuttings from wellbores, wellbore cleaning fluids, sealant compositions, completion fluids (for example, completion brines), workover fluids and spacer fluids.

For example, in one embodiment of the inventive process, the treatment fluid provided in accordance with the inventive process is a drilling fluid. The drilling fluid is introduced into the wellbore during the drilling process to lubricate the drill bit, carry cuttings out of the wellbore, maintain a hydrostatic head pressure on the wellbore and carry out other functions known to those skilled in the art. For example, the drilling fluid can be a synthetic, oil-based or water-based drilling fluid. It can contain a number of fluids (gaseous or liquid) and mixtures of fluids and solids (such as solid suspensions, mixtures and emulsions). By way of further example, the drilling fluid can be an aqueous based drilling mud incorporating a clay, such as bentonite.

In another embodiment of the inventive process, the treatment fluid provided in accordance with the inventive process is a cement composition. For example, the cement composition can be used in a primary cementing application such as to cement the casing in the wellbore. The cement composition can also be used in remedial cementing applications such as in squeeze cementing and the placement of cement plugs, and in other applications known to those skilled in the art. For example, in addition to the inventive bridging material, the cement composition can include a cement and water. A variety of cements can be used. Examples include hydraulic cements such as Portland cements, pozzolana cements, gypsum cements, high alumina-content cements, silica cements and combinations thereof. The density of the cement composition can be, for example, from about 5 pounds per gallon to about 24 pounds per gallon. The cement composition can be foamed or non-foamed.

The inventive bridging material and inventive process achieve effective lost circulation control and wellbore strengthening. The protein-based fibrous material used in the inventive bridging material gives the inventive bridging material excellent fracture-plugging characteristics. For example, soy protein fiber uniformly disperses in both water and oil and is thermally stable. It is stable in the high temperature conditions typically associated with oil and gas wells (up to 250° C.). Due to the fact that it is a natural product, soy protein fiber is environmentally friendly and bio-degradable.

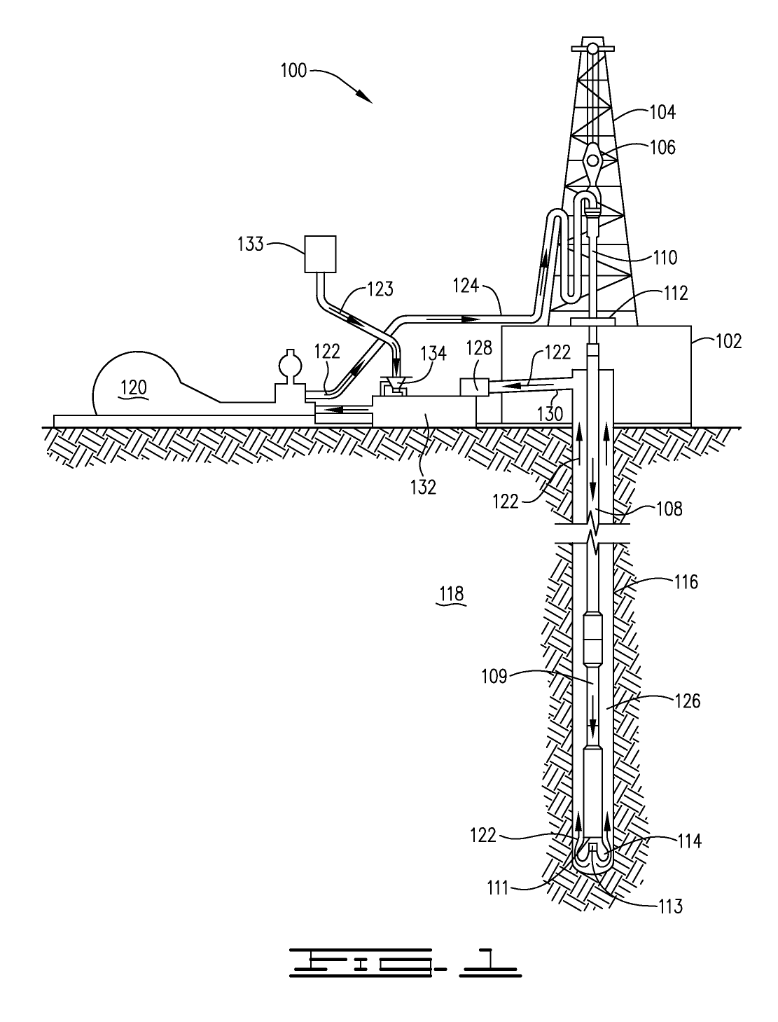

The exemplary fluids, compositions, chemicals, and additives disclosed herein may directly or indirectly affect one or more components or pieces of equipment associated with the preparation, delivery, recapture, recycling, reuse, and/or disposal of the disclosed fluids, compositions, chemicals, and additives. For example, and with reference to FIG. 1, the disclosed fluids, compositions, chemicals, and additives may directly or indirectly affect one or more components or pieces of equipment associated with an exemplary wellbore drilling assembly 100, according to one or more embodiments. It should be noted that while FIG. 1 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated by FIG. 1, the drilling assembly 100 may include a drilling platform 102 that supports a derrick 104 having a traveling block 106 for raising and lowering a drill string 108. The drill string 108 may include, but is not limited to, drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a borehole or wellbore 116 that penetrates various subterranean formations 118.

A pump 120 (e.g., a mud pump) circulates drilling fluid 122 through a feed pipe 124 and to the kelly 110, which conveys the drilling fluid 122 downhole through the interior of the drill string 108 and through one or more orifices 113 in the drill bit 114. The drilling fluid 122 is then circulated back to the surface via an annulus 126 defined between the drill string 108 and the walls of the borehole 116. At the surface, the recirculated or spent drilling fluid 122 exits the annulus 126 and may be conveyed to one or more fluid processing unit(s) 128 via an interconnecting flow line 130. After passing through the fluid processing unit(s) 128, a “cleaned” drilling fluid 122 is deposited into a nearby retention pit 132 (i.e., a mud pit). While illustrated as being arranged at the outlet of the wellbore 116 via the annulus 126, those skilled in the art will readily appreciate that the fluid processing unit(s) 128 may be arranged at any other location in the drilling assembly 100 to facilitate its proper function, without departing from the scope of the disclosure.

One or more of the disclosed fluids, compositions, chemicals, and additives may be added to the drilling fluid 122 via a mixing hopper 134 communicably coupled to or otherwise in fluid communication with the retention pit 132. The mixing hopper 134 may include, but is not limited to, mixers and related mixing equipment known to those skilled in the art. In other embodiments, however, the disclosed fluids, compositions, chemicals, and additives may be added to the drilling fluid 122 at any other location in the drilling assembly 100. In at least one embodiment, for example, there could be more than one retention pit 132, such as multiple retention pits 132 in series. Moreover, the retention pit 132 may be representative of one or more fluid storage facilities and/or units where the disclosed fluids, compositions, chemicals, and additives may be stored, reconditioned, and/or regulated until added to the drilling fluid 122.

As mentioned above, the disclosed fluids, compositions, chemicals, and additives may directly or indirectly affect the components and equipment of the drilling assembly 100. For example, the disclosed fluids, compositions, chemicals, and additives may directly or indirectly affect the fluid processing unit(s) 128 which may include, but are not limited to, one or more of a shaker (e.g., shale shaker), a centrifuge, a hydrocyclone, a separator (including magnetic and electrical separators), a desilter, a desander, a filter (e.g., diatomaceous earth filters), a heat exchanger, and any fluid reclamation equipment. The fluid processing unit(s) 128 may further include one or more sensors, gauges, pumps, compressors, and the like used store, monitor, regulate, and/or recondition the exemplary fluids, compositions, chemicals, and additives.

The disclosed fluids, compositions, chemicals, and additives may directly or indirectly affect the pump 120, which representatively includes any conduits, pipelines, trucks, tubulars, and/or pipes used to fluidically convey the fluids, compositions, chemicals, and additives downhole, any pumps, compressors, or motors (e.g., topside or downhole) used to drive the fluids, compositions, chemicals, and additives into motion, any valves or related joints used to regulate the pressure or flow rate of the fluids, compositions, chemicals, and additives, and any sensors (i.e., pressure, temperature, flow rate, etc.), gauges, and/or combinations thereof, and the like. The disclosed fluids, compositions, chemicals, and additives may also directly or indirectly affect the mixing hopper 134 and the retention pit 132 and their assorted variations.

The disclosed fluids, compositions, chemicals, and additives may also directly or indirectly affect the various downhole equipment and tools that may come into contact with the fluids, compositions, chemicals, and additives such as, but not limited to, the drill string 108, any floats, drill collars, mud motors, downhole motors and/or pumps associated with the drill string 108, and any MWD/LWD tools and related telemetry equipment, sensors or distributed sensors associated with the drill string 108. The disclosed fluids, compositions, chemicals, and additives may also directly or indirectly affect any downhole heat exchangers, valves and corresponding actuation devices, tool seals, packers and other wellbore isolation devices or components, and the like associated with the wellbore 116. The disclosed fluids, compositions, chemicals, and additives may also directly or indirectly affect the drill bit 114, which may include, but is not limited to, roller cone bits, PDC bits, natural diamond bits, any hole openers, reamers, coring bits, etc.

While not specifically illustrated herein, the disclosed fluids, compositions, chemicals, and additives may also directly or indirectly affect any transport or delivery equipment used to convey the fluids, compositions, chemicals, and additives to the drilling assembly 100 such as, for example, any transport vessels, conduits, pipelines, trucks, tubulars, and/or pipes used to fluidically move the fluids, compositions, chemicals, and additives from one location to another, any pumps, compressors, or motors used to drive the fluids, compositions, chemicals, and additives into motion, any valves or related joints used to regulate the pressure or flow rate of the fluids, compositions, chemicals, and additives, and any sensors (i.e., pressure and temperature), gauges, and/or combinations thereof, and the like.

Referring now to FIG. 1, the inventive system for drilling a wellbore 116 from the surface into a subterranean formation 118 with minimal or no loss of drilling fluid 122 into the formation will be described. The system comprises a source 132 of drilling fluid 122, which is represented in FIG. 1 as a retention pit or mud pit, and a source 133 of the inventive bridging material 123. The source 133 of the inventive bridging material 123 can be, for example, a truck load or other type of container containing the bridging material.

A wellbore drilling assembly 100 is associated with the source 132 of drilling fluid 122 and the source 133 of bridging material 123. The wellbore drilling assembly 100 includes a drilling platform 102 and a derrick 104 supported by the drilling platform. The derrick 104 has a traveling block 106. A drill string 108 that can be raised and lowered by the traveling block 106 is also included. The drill string 108 has an interior 109 and a distal end 111. A drill bit 114 is attached to the distal end 111 of the drill string 108, whereby the drill bit can be rotated to create the wellbore 116. The drill bit 114 has one or more orifices 113 therein. A mixing apparatus 134, shown by FIG. 1 in the form of a mixing hopper, is included for admixing bridging material 123 from the source 133 of bridging material into drilling fluid 122 from the source 132 of drilling fluid. A pump 120 for circulating drilling fluid 122 including the bridging material 123 from one of the source 132 of drilling fluid and the source 133 of bridging material through the interior 109 of the drill string 108, through said orifice(s) 113 of the drill bit 114 and back to the surface through an annulus 126 defined between the drill string and the wall of the wellbore 116 is also included.

### EXAMPLES

The present invention is exemplified by the following examples. The examples are not intended and should not be taken to limit, modify or define the scope of the present invention in any manner.

### Example I

The dispersibility of soy protein fiber (SPF) in both water and oil was determined based on visual observation. In each test, about one gram of SPF was added to 100 ml of the base medium (water in the first test, oil in the second test), and the components were vigorously mixed together with a spatula. In each test, it was visually observed that the SPF dispersed reasonably uniformly into the base medium in that agglomerates were not formed.

### Example II

A thermo-gravimetric analysis (TGA) of soy protein fiber (SPF) was carried out. The analysis was carried out using a thermo-gravimetric analyzer (TA Instruments Model Q500) operating under a nitrogen atmosphere, at a temperature of from 25° C. to 870° C. and at a heating rate of 10° C. per minute.

The results of the tests are shown in Table 2 below:

TABLE 2
Thermo-gravimetric Analysis (TGA) of Soy Protein Fiber

| Temperature (° C.) | Weight (%) |
|---|---|
| 51.44 | 98.33 |
| 100.15 | 97.42 |
| 148.22 | 97.04 |
| 199.33 | 96.55 |
| 249.79 | 95.30 |
| 276.62 | 93.97 |
| 300.42 | 90.48 |
| 325.49 | 84.26 |
| 350.40 | 74.56 |
| 399.60 | 41.67 |
| 499.74 | 7.907 |
| 599.87 | 6.480 |

As shown by the results, the soy protein fibers are stable up to 250° C. (482° F.). Thus, soy protein fiber is a highly stable product.

### Example III

The plugging efficiency of the inventive bridging material was tested. In carrying out the test, a bridging material consisting of 1% by weight soy protein fiber (SPF), based on the total weight of the bridging material, and 99% by weight walnut hulls, based on the total weight of the bridging material, was utilized. The SPF had a specific gravity of 1.29 and a fiber length of 6 mm The walnut hulls used in the tests had a d₅₀ particle size of 950 micrometers.

The bridging material was tested using a Particle Plugging Apparatus (“PPA”). The PPA used to carry out the tests had a 2.5 mm constant area slot.

In carrying out the tests, approximately 50 pounds per barrel of the walnut hulls and approximately 0.5 pounds per barrel of the SPF were added to one barrel of the base drilling fluid. The base drilling fluid was a water-based drilling fluid having a mud weight of 12 pounds per gallon.

The combined composition was then vigorously mixed with a spatula and added to the PPA cell. The mixture was pushed through the 2 5 mm constant area slot under a differential pressure of 500 psi. The constant area slot of the PPA became plugged efficiently after an initial fluid loss of about 20 ml.

Thus, the tests show that the inventive bridging materials can be effectively used to plug wellbore and formation fractures.

### Prophetic Example

The following prophetic example is provided to illustrate the inventive process. The example was not actually carried out.

The inventive bridging agent is introduced into an aqueous based drilling fluid incorporating bentonite clay. The bridging agent is introduced into the drilling fluid on the fly at the well site such that the bridging agent is present in the drilling fluid in an amount of about 30 pounds per barrel of drilling fluid, and the drilling fluid is continuously injected into the drill string. In this prophetic example, the inventive bridging agent consists of soy protein fiber (SPG) having a specific gravity of 1.29 and an average fiber length of about 6 millimeters.

As the drilling fluid reaches the drill head, it flows through the hollow interior of the drill and through apertures on the drill head where it exits into the wellbore in the region between the borehole wall and the drill head and, subsequently flows upward through the annulus, between the wellbore and outside of the drill string.

The inventive bridging agent is drawn toward areas of fluid loss. The bridging agent plugs the areas of fluid loss to reduce and/or prevent further fluid loss.

Thus, the present invention is well adapted to carry out the objects and attain the ends and advantages mentioned as well as those which are inherent therein.

What is claimed is:

1. A bridging material for a wellbore treatment fluid, said bridging material comprising a protein-based fibrous material and at least one additional material, said additional material being a lost circulation material.

2. The bridging material of claim 1, wherein said protein-based fibrous material is selected from the group consisting of soy protein fiber, milk protein fiber and mixtures thereof.

3. The bridging material of claim 1, wherein said protein-based fibrous material has a length to diameter aspect ratio in the range of from about 2:1 to about 5,000:1.

4. The bridging material of claim 1, wherein said protein-based fibrous material has a fiber length in the range of from about 0.5 mm to about 25 mm.

5. The bridging material of claim 1, wherein said protein-based fibrous material has a density in the range of from about 0.5 g/cm³ to about 4.5 g/cm³.

6. The bridging material of claim 2, wherein said protein-based fibrous material is soy protein fiber.

7. The bridging material of claim 1, wherein said additional material is selected from the group consisting of non-protein based fibrous materials, flaky materials, particulate materials and mixtures thereof.

8. The bridging material of claim 6, wherein said additional material is a particulate material.

9. The bridging material of claim 7, wherein said particulate material has a d₅₀ particle size in the range of from about 5 μm to about 25,000 μm.

10. The bridging material of claim 9, wherein said particulate lost circulation material consists of nut hulls.

11. The bridging material of claim 10, wherein said nut hulls are walnut hulls.

12. The bridging material of claim 6, wherein said bridging material comprises about 0.1% to about 50% by weight, based on the total weight of said bridging material, of said protein-based fibrous material, and in the range of from about 50% to about 99.9% by weight, based on the total weight of said bridging material, of said additional material(s).

13. A process for treating a wellbore penetrating a subterranean formation with minimal or no loss of treatment fluid into the formation, comprising:
(a) providing a treatment fluid that includes a bridging material, said bridging material comprising a protein-based fibrous material and at least one additional material, said additional material being a lost circulation material; and
(b) introducing said treatment fluid into said wellbore.

14. The process of claim 13, wherein said protein-based fibrous material is selected from the group consisting of soy protein fiber, milk protein fiber and mixtures thereof.

15. The process of claim 13, wherein said protein-based fibrous material has a length to diameter aspect ratio in the range of from about 2:1 to about 5,000:1.

16. The process of claim 13, wherein said protein-based fibrous material has a fiber length in the range of from about 0.5 mm to about 25 mm.

17. The process of claim 13, wherein said protein-based fibrous material has a density in the range of from about 0.5 g/cm³ to about 4.5 g/cm³.

18. The process of claim 14, wherein said protein-based fibrous material is soy protein fiber.

19. The process of claim 13, wherein said additional material is selected from the group consisting of non-protein based fibrous materials, flaky materials, particulate materials and mixtures thereof.

20. The process of claim 19, wherein said additional material is a particulate lost circulation material.

21. The process of claim 20, wherein said particulate lost circulation material consists of nut hulls.

22. The process of claim 21, wherein said nut hulls are walnut hulls.

23. The process of claim 13, wherein said protein-based fibrous material is present in said treatment fluid in an amount in the range of about 0.1 pounds to about 25 pounds of protein-based fibrous material per barrel of treatment fluid.

24. The process of claim 13, wherein said additional material is present in said treatment fluid in an amount in the range of about 0.1 pounds to about 100 pounds of additional lost circulation material per barrel of treatment fluid.

25. The process of claim 13, wherein said treatment fluid is a drilling fluid.

26. A system for drilling a wellbore from the surface into a subterranean formation with minimal or no loss of drilling fluid into the formation, comprising: a source of drilling fluid;
a source of a bridging material, said bridging material comprising a protein-based fibrous material and at least one additional material, said additional material being a lost circulation material; and
a wellbore drilling assembly associated with said source of drilling fluid and said source of bridging material, said wellbore drilling assembly including:
a drilling platform;
a derrick supported by said drilling platform, said derrick having a traveling block;
a drill string that can be raised and lowered by said traveling block, said drill string having an interior and a distal end;
a drill bit attached to said distal end of said drill string, whereby said drill bit can be rotated to create the wellbore, said drill bit having one or more orifices therein;
a mixing apparatus for admixing bridging material from said source of bridging material into drilling fluid from said source of drilling fluid; and
a pump for circulating drilling fluid including said bridging material from one of said source of drilling fluid and said source of bridging material through the interior of said drill string, through said orifice(s) of said drill bit and back to the surface through an annulus defined between said drill string and the wall of said wellbore.

27. The system of claim 26, wherein said protein-based fibrous material of said bridging material is selected from the group consisting of soy protein fiber, milk protein fiber and mixtures thereof.

28. The system of claim 27, wherein said protein-based fibrous material is soy protein fiber.

29. The system of claim 26, wherein said additional material of said bridging material is selected from the group consisting of non-protein based fibrous materials, flaky materials, particulate materials and mixtures thereof.

30. The system of claim 29, wherein said additional material is a particulate lost circulation material.

31. The system of claim 30, wherein said particulate lost circulation material consists of nut hulls.

32. The system of claim 31, wherein said nut hulls are walnut hulls.

33. The system of claim 26, wherein said protein-based fibrous material of said bridging material is admixed by said mixing apparatus into said drilling fluid in an amount in the range of about 0.1 pounds to about 25 pounds of protein-based fibrous material per barrel of drilling fluid.

34. The system of claim 26, wherein said additional material of said bridging material is admixed by said mixing apparatus into said drilling fluid in an amount in the range of about 0.1 pounds to about 100 pounds of additional lost circulation material per barrel of drilling fluid.

35. The system of claim 26 wherein said source of drilling fluid is a retention pit.
